(19) United States
(12) Patent Application Publication
(10) Pub. No.: US 2017/0283229 A1
(43) Pub. Date: Oct. 5, 2017

(54) SCISSOR-BOOM LIFT

(71) Applicant: DongFeng Shi, Sammamish, WA (US)

(72) Inventor: DongFeng Shi, Sammamish, WA (US)

(21) Appl. No.: 15/472,702

(22) Filed: Mar. 29, 2017

(30) Foreign Application Priority Data
Mar. 29, 2016 (CN) 2016 2 2025097

(51) Int. Cl. B66F 11/04; B66F 17/00

(52) U.S. Cl. CPC B66F 11/042; B66F 17/006

(57) ABSTRACT

A scissor boom system including a scissor boom assembly having a telescopic boom section including a base-boom, a middle-boom, and a top-boom, a scissor links assembly, a chassis, and a power hoist. The chassis supports the power hoist, the power moves the telescopic boom section and the scissor links assembly between raised and lowered conditions when manipulated. The scissor boom assembly provides a stable work platform for workers. The telescopic boom section provides for horizontal-movement of a work platform, and the scissor links assembly is thus able to provide vertical-movement of the work platform, as desired.

### CROSS REFERENCE TO RELATED APPLICATIONS

This application claims priority to copending Chinese Application, Serial No. ZL 2016 2 20250971.6, filed on Mar. 29, 2016, which is hereby incorporated by reference for all purposes.

### BACKGROUND

The present disclosure relates generally to lifting devices. In particular, a scissor-boom lift is described.

Known lifting devices are currently grouped into 2 categories: (1) The scissor lifts, which use the scissor links folding and unfolding to change the lifts height and they have no far outreach capability (2) The boom lifts, which use the telescope booms' extension, retraction and angel movement to change the lifts top platform height and outreach distance. Current lifts are not entirely satisfactory for the range of applications in which they are employed. For example, scissor lifts do not have far outreach capability and thus their application are very limited. Boom lifts are complicated to operate and expensive to own.

Thus, there exists a need for lifting devices that improve upon and advance the design of known lifting devices. Examples of new and useful lifting device relevant to the needs existing in the field are discussed below.

Examples of references relevant to lifting means include U.S. Pat. Nos. 6,330,933; 4,691,805, and 5,740,887. The complete disclosures of the above patents and patent applications are herein incorporated by reference for all purposes.

### SUMMARY

The present disclosure is directed to a scissor-boom lift. In some examples, scissor-boom lift includes a scissor boom assembly having a horizontal telescopic boom assembly at the top including a base-boom, a middle-boom, and a top-boom which also acts as the platform, a scissor links assembly in the middle, and a chassis at the bottom. The 3-section horizontal telescope boom, powered by a power hoist, can extend or retract to change the platform's outreach distance. The scissor links, powered by a hydraulic cylinder, can fold and unfold to change the platform's working height. The chassis, with 2 front steering wheels and 2 rear wheels, allows the scissor-boom lift to travel and turn. All above mentioned movement can be controlled separately by a single joystick located inside the platform.

Compared to the current scissor lifts on the markets, the scissor-boom lift provides an outreach capability when the 3 section horizontal telescopic boom extend out and thus can reach those working objects that scissor lifts cannot reach. Compared to the current boom lifts on the market, the scissor-boom lift is much cheaper in cost and also simpler to control and maintain.

### BRIEF DESCRIPTION OF THE DRAWINGS

FIG. 1 is a perspective view of a first example of a scissor-boom lift in an in-use condition, an operator operating the device via a handheld controller; the device in a raised position.

FIG. 2 is a perspective view of the scissor-boom lift shown in FIG. 1 depicting the device in a stored position for transport.

FIG. 3 is a perspective view of the scissor-boom lift showing the device horizontal and vertical movement range with indication arrows between stored position and the fully extended and raised position.

FIG. 4 is a perspective view of a second example of a scissor-boom lift including the top section of the device moving horizontally out and up from the lowered portion.

FIG. 5 is a perspective view of a second example of a scissor-boom lift including the top section of the device moving horizontally in and down from the raised portion.

FIG. 6 is a perspective view of the telescopic middle-boom extent and retract movement mechanism of the scissor-boom lift.

FIG. 7 is a perspective view of the telescopic top-boom simultaneous extending mechanism of the scissor-boom lift.

FIG. 8 is a perspective view of the telescopic top-boom simultaneous retracting mechanism of the scissor-boom lift.

FIG. 9 is a perspective view of the top-boom, middle boom and base boom major structure.

FIG. 10 is a sectioned view to show telescopic boom assembly connection to the scissor links and also the control cable retractable drum and bracket layout on the telescopic boom assembly.

FIG. 11 is perspective view of the scissor links assembly and its connection to the telescopic boom assembly at the top and to the chassis at the bottom.

FIG. 12 is the perspective view of the chassis.

FIG. 13 is the perspective view of the single joystick controller controlling all the scissor-boom lift's movement.

### DETAILED DESCRIPTION

The disclosed lifting device will become better understood through review of the following detailed description in conjunction with the figures. The detailed description and figures provide merely examples of the various inventions described herein. Those skilled in the art will understand that the disclosed examples may be varied, modified, and altered without departing from the scope of the inventions described herein. Many variations are contemplated for different applications and design considerations; however, for the sake of brevity, each and every contemplated variation is not individually described in the following detailed description.

Throughout the following detailed description, examples of various lifting devices are provided. Related features in the examples may be identical, similar, or dissimilar in different examples. For the sake of brevity, related features will not be redundantly explained in each example. Instead, the use of related feature names will cue the reader that the feature with a related feature name may be similar to the related feature in an example explained previously. Features specific to a given example will be described in that particular example. The reader should understand that a given feature need not be the same or similar to the specific portrayal of a related feature in any given figure or example.

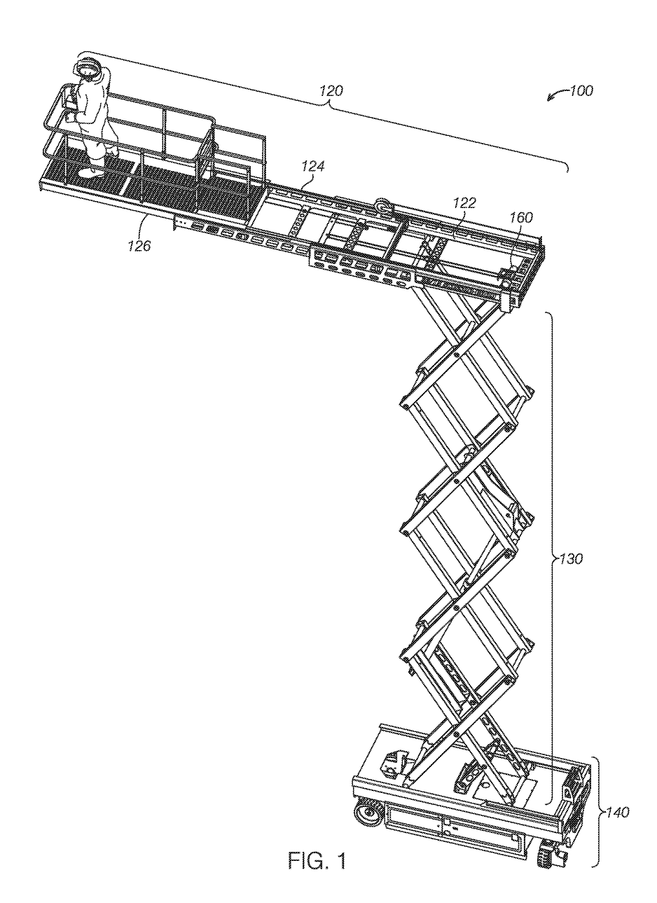

Generally speaking, the present invention refers to a new scissor-boom lift as shown in FIG. 1 which includes a 3-section telescopic boom 120 at the top that can extents or retracts horizontally, a scissor link assembly 130 in the ‘mid’ that can fold or unfold vertically and a chassis 140 at the bottom that can travel or turn. Each of these movements can be controlled separately by a joystick controller located inside the working platform.

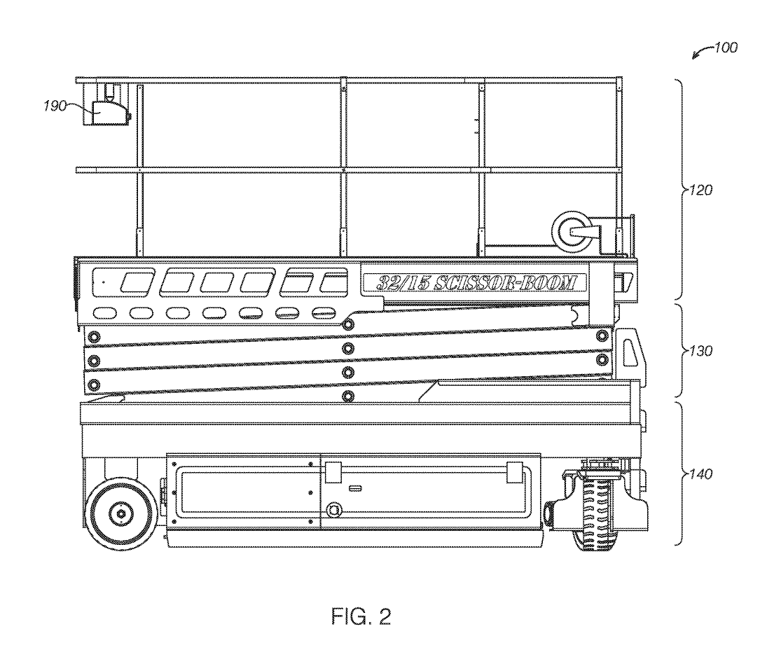

With reference now to FIGS. 1-5, a first example of a scissor-boom lift 100; scissor-boom lift 100, will now be described. Scissor-boom lift 100 functions to provide an adjustable work platform with vertical-movement and horizontal-movement of the work platform, as desired. The reader will appreciate from the figures and description below that scissor-boom lift 100 addresses shortcomings of conventional lifting devices. As shown in FIG. 1, a scissor-boom lift 100 at a fully extended and raised position is disclosed herein including a telescopic boom assembly 120 at the top including a base-boom 122, a middle-boom 124, and a top-boom 126, a scissor links assembly 130 in the middle, and a chassis 140 at the bottom. FIG. 2 shows the scissor-boom lift 100 in a stored position, with the top telescopic boom section 120 fully retracted and the scissor links 130 fully folded.

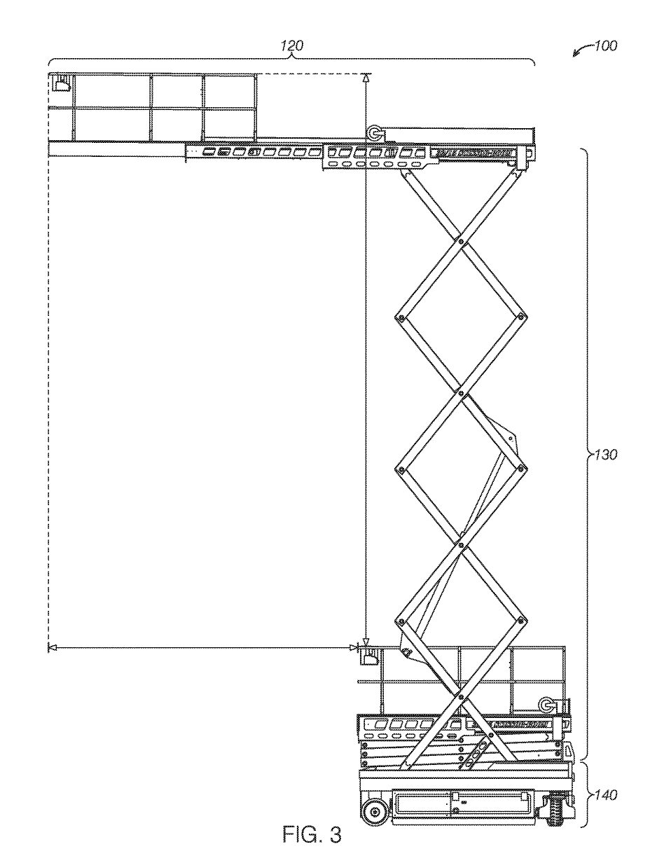

The telescope boom assembly 120, is coupled to the scissor links assembly 130 and powered by power hoist 160 located at the front end of base boom 122, providing a stable work platform for workers as shown in FIG. 1 and also provides for horizontal-movement of a work platform as shown in FIGS. 3-5. FIG. 3 shows the range of vertical and horizontal movement of the platform from stored position to the fully extended and raised position. The scissor links assembly 130, powered by hydraulic cylinder, supports the top telescopic boom assembly 120 and provides the vertical-movement of the work platform. The chassis 140 supports the scissor link assembly 130 and can travel and turn. It also supports the counterweights at the front end to counterbalance the tipping moment.

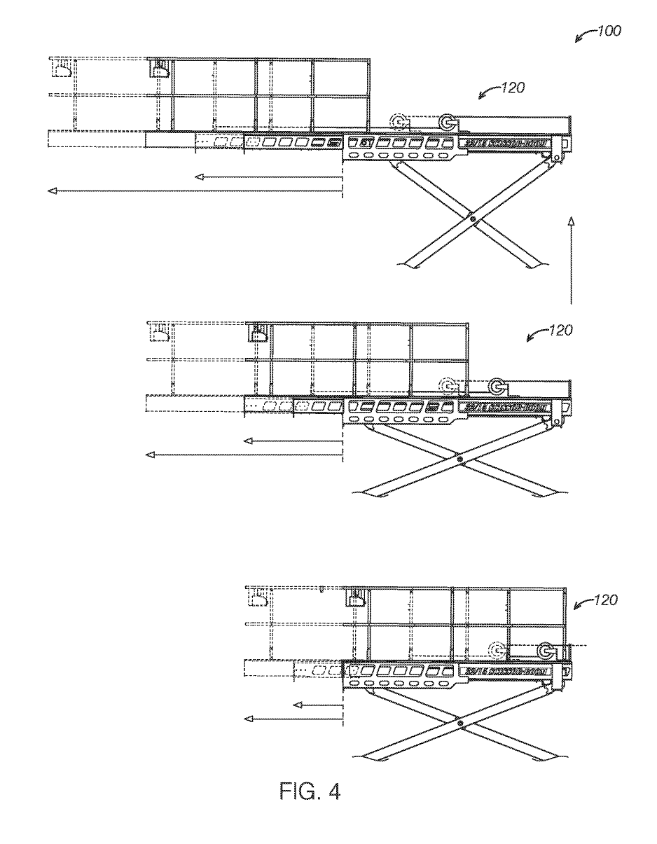

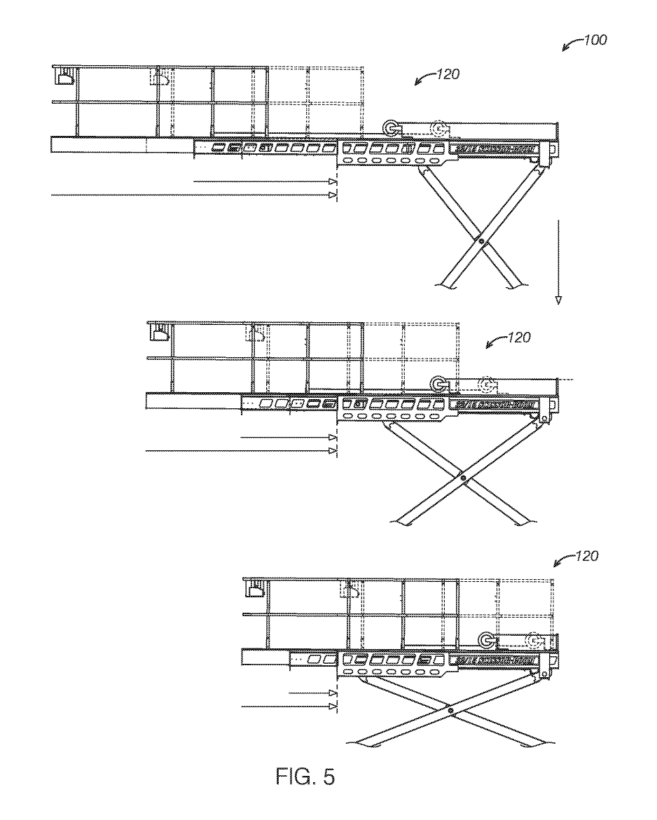

FIG. 4 shows the telescopic boom assembly 120 making the simultaneously extension and the scissor links unfolding movement from retracted and lowered position to the extended and raised position and FIG. 5 shows the telescopic boom assembly 120 making the simultaneously retraction and the scissor links folding movement from extended and raised position to the retracted and lowered position. The details of the telescopic boom assembly 120, the scissor link assembly 130 and the chassis 140 will be depicted below with reference to the drawings.

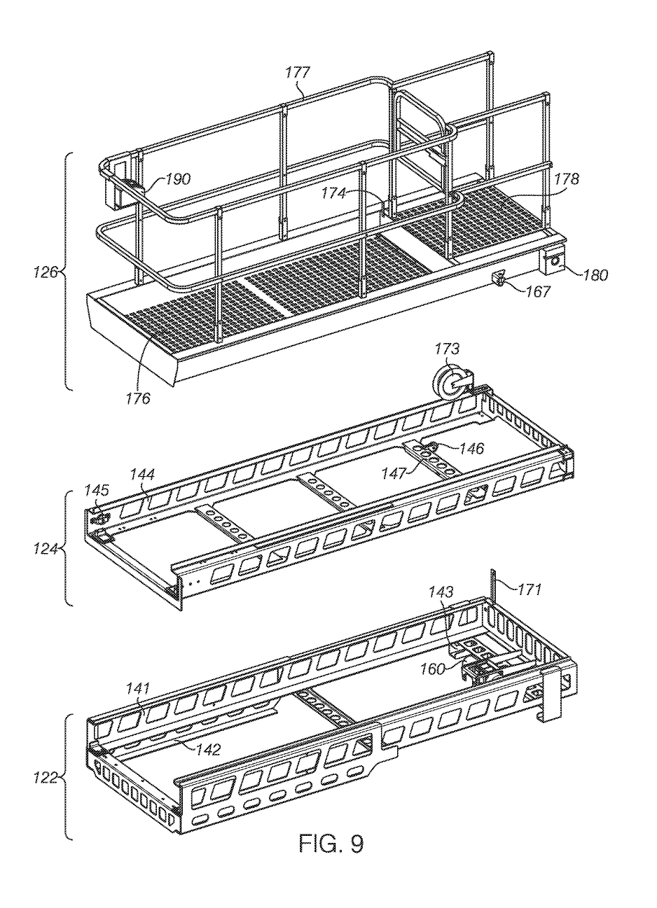

Telescopic boom assembly 120, as shown in FIG. 1; the 3-section telescopic boom assembly 120 includes the base-boom 122, the middle-boom 124, and the top-boom 126. The top-boom 126 also acts as the platform for a worker. As shown in FIG. 9, the base-boom 122 has a top-base-boom-channel 141 on top right side and top left side allowing the middle-boom 124 to nest in and slide along the top-base-boom-channel 141. The base-boom 122 also includes the pivot pin bracket 143 at the bottom front to pivot to a top front scissor link 135 (135 will be described subsequently).

The base-boom 122 has a bottom-base-boom-channel 142 at bottom left side and bottom right side of the rear half that allows a top rear link 138 to sit in through a sliding block 185 (138 and 185 will be described subsequently) and slide along the base-boom-channel 142 when the scissor links assembly 130 folds and unfolds. The base-boom 122 further includes the control cable bracket 171 at the front end for holding the control cable when the platform extends and retracts. The top of the base-boom 122 are open so the top-boom 126 and middle-boom 124 can slide all the way into the top open space when fully retracted.

A power hoist 160 is preferably mounted at the front bottom of the base-boom 122 to provide power for telescopic boom assembly 120's extension and retraction. As shown in FIG. 9, the middle-boom 124 has a middle-boom-channel 144 on both sides of the top allowing the top-boom 126 to sit in and slide along when the top-boom 126 extends and retracts. The outside of the middle-boom-channel 144 sits inside the top base-boom-channel 141 and slide along when middle-boom 124 extends and retracts. The middle boom 124 also comprises an extension cable vertical pulley 145 mounted at the rear end inside the right and left middle-boom-channel 144. The middle-boom 124 also comprises a retraction cable pulley 146 mounted at the left and right side of a cross beam 147 at the bottom close to the front end of the middle-boom 124. The middle-boom 124 further comprises a control cable retractable drum 173 mounted at a front end of the middle-boom 124.

As shown in FIG. 9, the top-boom 126 has a working floor 176 and rail 177 on the top rear half of top-boom 126 that form a working platform allowing an operator to stand during work. A control box 190 is hanged on the rail 177. The top-boom 126 also has the walking surface 178 at the front end of the top-boom 126 that allows the operator to walk through to get in or leave the working platform. A sliding block 180 is pivoted to each side of the top boom 126 at the front end and the sliding block 180 is fitted into the middle-boom-channel 144 allowing the top-boom 126 to slide along the middle-boom-channel 144. An extension cable horizontal pulley 167 is mounted on each side of the top boom 126 next to the sliding block 180.

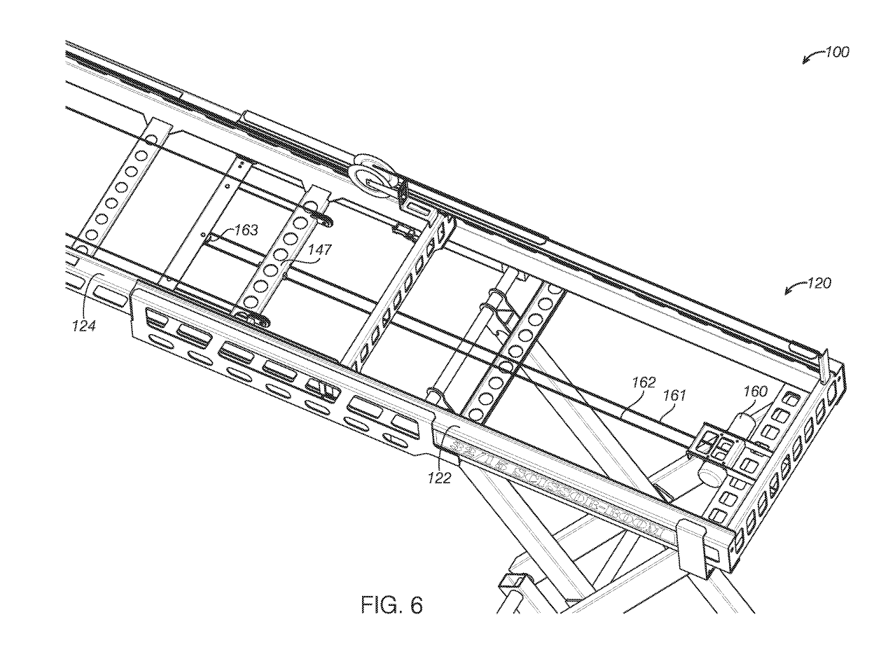

FIG. 6 illustrates how the middle-boom 124 extents and retracts; a middle-boom extension cable 161 and a middle-boom retraction cable 162 are mounted to the power hoist 160 on one end, with one cable wrapping to the power hoist 160 from the bottom and the other cable wrapping to the power hoist 160 from the top so at any time when the power hoist 160 rotates, one cable will be wrapped into and the other one will be wrapped out from the power hoist 160. The other end of the middle-boom extension cable 161 goes over a cable pulley 163 mounted at the bottom rear end of base-boom 122, turns 180 degree there and then is fixed to the cross beam 147 on the middle-boom 124.

The other end of the middle-boom retraction cable 162 is directly fixed to the cross beam 147. The power hoist 160, middle-boom extension cable 161, cable pulley 163, cross beam 147 and middle-boom retraction cable 162 form a closed loop. When the power hoist 160 rotates, if the middle-boom extension cable 161 is wrapped into the power hoist 160, it will pull the cross-beam 146 away from the power hoist 160 through cable pulley 163 and thus the middle-boom 124 will extend out of the base-boom 122; if the middle-boom retraction cable 162 is wrapped into the power hoist 160, it will pull the cross-beam 146 toward power hoist 160 directly and thus the middle-boom 124 will retract into the base-boom 122. The operator can control the middle-boom 124's extension or retraction by controlling the power hoist 160 rotation direction through control box 190.

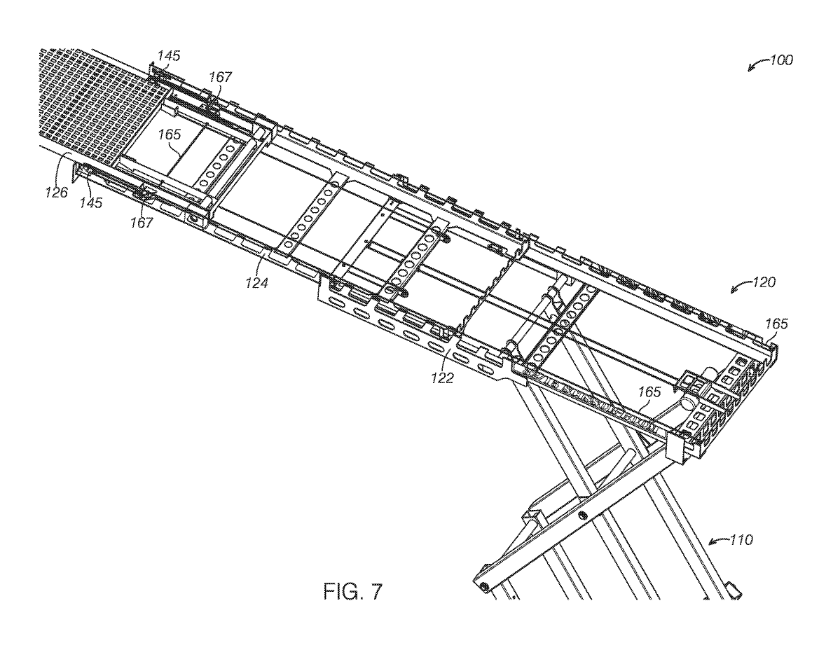

As shown in FIG. 7, the top-boom 126 extends simultaneously when middle-boom 124 extends since a top-boom extension cable 165 is used to push top-boom 126 out of middle-boom 124 when middle-boom 124 extents. The path of the top boom extension cable 165 starts with its one end fixed to the right front end of the base boom 122, the other end goes inside and along the base-boom top channel 141 and middle-boom channel 144 on the right side to wrap on the right extension vertical pulley 145 located at the rear end of the middle-boom channel 124 and makes the 180 degree turn, then it wraps onto the right horizontal pulley 167 located at the front bottom of top-boom 126 and makes a 90 degree turn to wrap onto the left horizontal pulley 167, it turns 90 degree again there and then goes to wrap onto the left extension vertical pulley 145 located at the rear end the middle-boom 124 on the other side. Then it goes inside and along the middle-boom channel 144 and base-boom top channel 141 on this side and finally is fixed to the front end of base-boom 122. When the power hoist 160 rotates and pushes middle-boom 124 to extend backwardly, the right and left extension vertical pulley 145 move together with middle-boom 124 and thus will push the top boom extension cable 165 to move backward also. Since the two ends of the top boom extension cable 165 are fixed to the base-boom 122's front end and thus do not move, then the middle section of the top boom extension cable 165 that goes between the right and left extension horizontal pulley 167 of the top-boom 126 will move backward at the double speed of the middle-boom 124 and thus push the top-boom 126 to extent simultaneously out of the middle-boom 124 when middle-boom 124 extends.

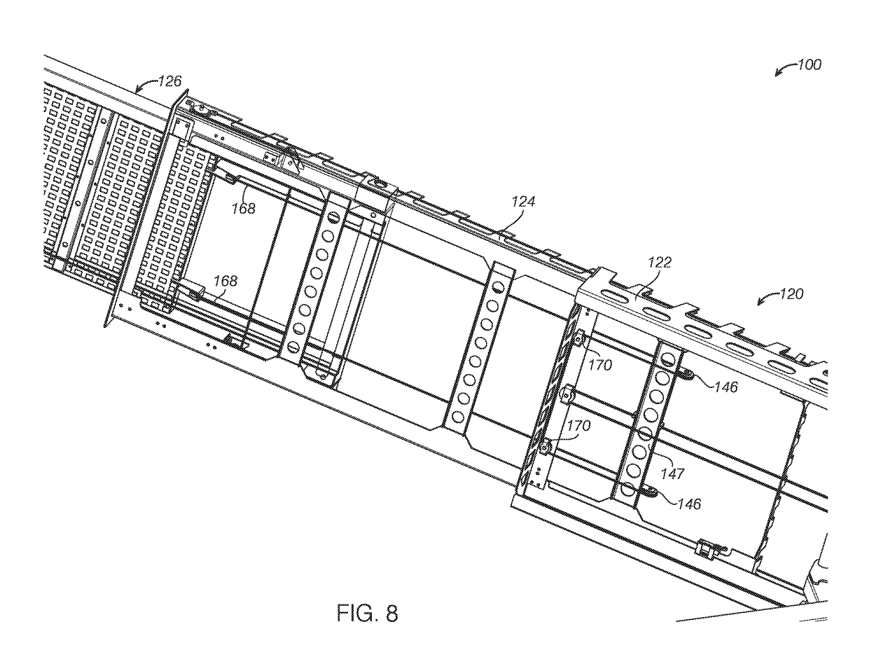

As shown in FIG. 8, the top-boom 126 retracts simultaneously when the middle-boom 124 retracts since a top-boom retraction cable 168 is used to pull the top-boom 126 back to middle-boom 124 simultaneously when middle-boom 124 retracts. The path of the top-boom retraction cable 168 starts with its one end anchored to the right bottom at the front half of the top-boom 126, the other end of the retraction cable 168 goes through the bottom of the middle-boom 124 and wraps onto the top boom retraction pulley 146 mounted at the cross beam 147 at the bottom right front of the middle-boom 124 and makes 180 degree turn. It then passes through the right horizontal pulley 170 mounted at the rear end of base-boom 122 and makes 90 degree turns to go to the other horizontal pulley 170 on the left and makes another 90 degree turn there. It then passes through the other pulley 169 mounted at the bottom left front of the middle-boom 124, makes 180 degree turns there and then goes through the bottom of the middle-boom 124 and then finally be anchored to the left bottom at the front half of top-boom 126.

When the middle-boom 124 retracts into the base-boom 122, the two top boom retraction cable pulleys 169 mounted at the bottom front of the middle-boom 124 move together with the middle-boom 124 and thus pull the top boom retraction cable 168 to move toward the front end of the base-boom 122. Since the middle section of the top boom retraction cable 168 that goes between the two horizontal pulley 170 mounted at the bottom rear of the base-boom 122 will not move, the two end of the top boom retraction cable 168 that are anchored to the top-boom 126's bottom front will be pulled at the double speed of the middle-boom 124 retraction movement and thus the top-boom 126 is then pulled simultaneously to move towards the front end of the base-boom 122 when middle-boom 124 retracts.

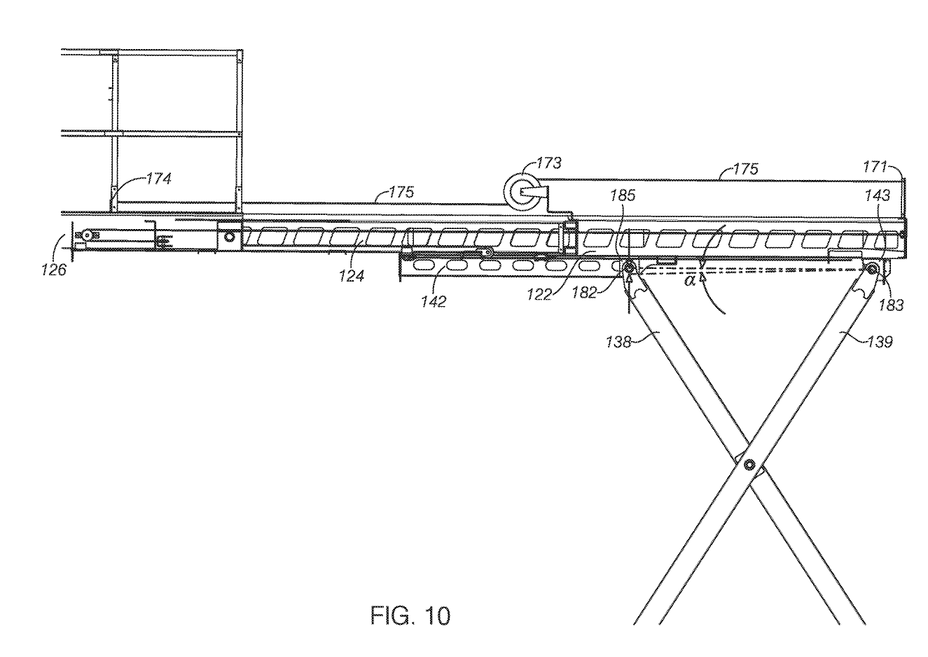

The control box 190 is preferably located on the top-boom 126 and is connected to the scissor links assembly 130 and chassis 140 by control cable 175. As shown in FIG. 10, when the top-boom 126 extends or retracts, the control cable 175 will also expend or retract together with the top-boom 126. This is accomplished by a front cable bracket 172 mounted at the front end of base-boom 122, a rear cable bracket 174 mounted at the front half of the top-boom 126 and a retractable cable drum 173 mounted at the front end of middle-boom 124. The control cable 175's front end is fixed to the front cable bracket 172 on the base-boom 122, the rear end of the control cable 175 is rewound into the right half of the retractable cable drum 173 from the top for several rounds, then is turned 180 degree to be rewound to the left half of the retractable cable drum 173 for several rounds and is rewound out of the retractable cable drum 173 from the bottom and then anchored to the cable rear end bracket 174 on the top-boom 126 at the rear end. Since the control cable 175 is rewound into the retractable cable drum 173 from the top and rewound out from the bottom, so when retractable cable drum 173 rotates, it will rewind or unwind the top and bottom cable simultaneously in opposite direction.

The retractable cable drum 173 always rewinds the cable to its drum by either the springs or motor inside the drum and thus there is always tension on the control cable 175 to make it ‘straight’ all the time. When the middle-boom 124 extends, the top-boom 126 also extends twice the speed of the middle-boom 124 so the control cable 175 is pulled out from the retractable cable drum 173 from both the top and bottom when the middle-boom 124 and the top-boom 126 extend. When the middle-boom 124 and the top-boom 126 retracts, the control cable 175 is also retracted to the retractable cable drum 173 by the forces of springs or motor inside the drums from both the top and bottom.

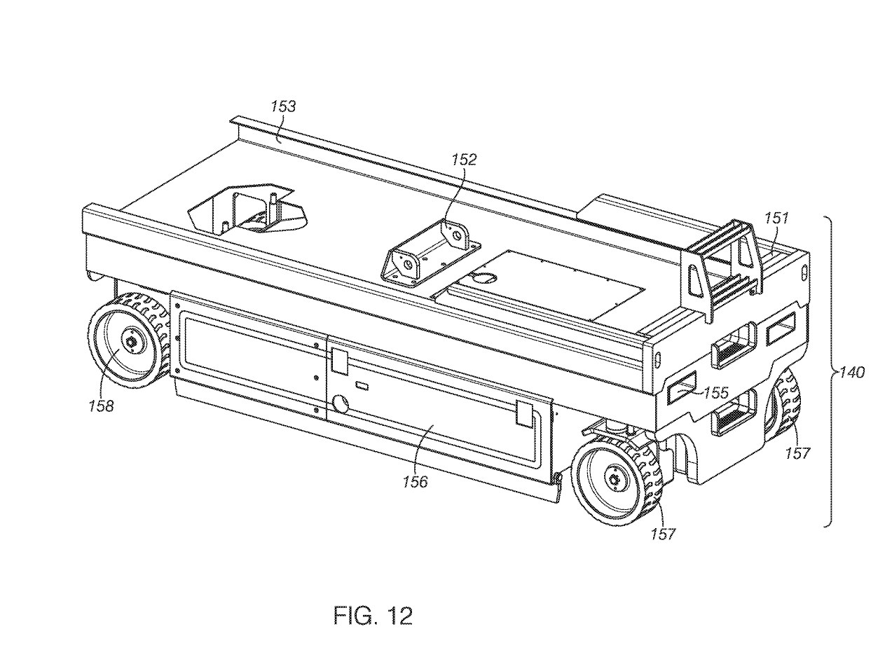

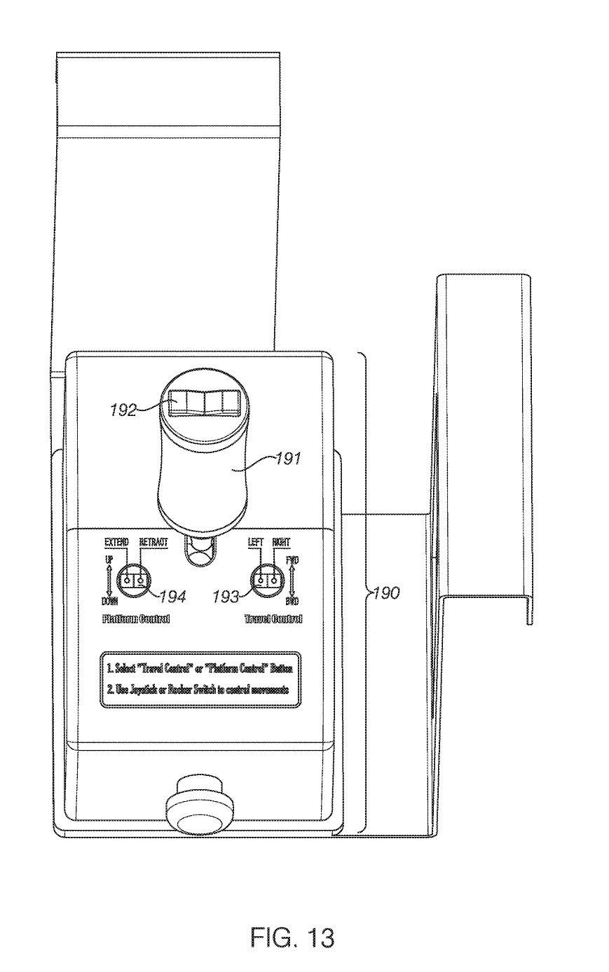

As shown in FIG. 13, the control box 190 comprises of a joystick 191 and rock switch 192 that control both the chassis 140's travel and steering movement, as well as the top boom 126's vertical and horizontal movement. Also as shown in FIG. 12, on the control box 190, there are two control push buttons—travel control button 193 and platform control button 194 that can be selected to allow the operator to select which movement control to select. If the “Travel Control” button 193 is pushed, then the joystick 191 will control the chassis 140's forward and backward travel and the rock switch 192 will control the front wheels steering direction. If the “Platform Control” 194 button is pushed, then the joystick 191 will control the scissor links unfold or fold movement, allowing the platform to go up or down and the rock switch 192 will control the extension or retraction of the telescopic boom assembly 120's extension or retraction on the top, allowing the platform to outreach or retract in.

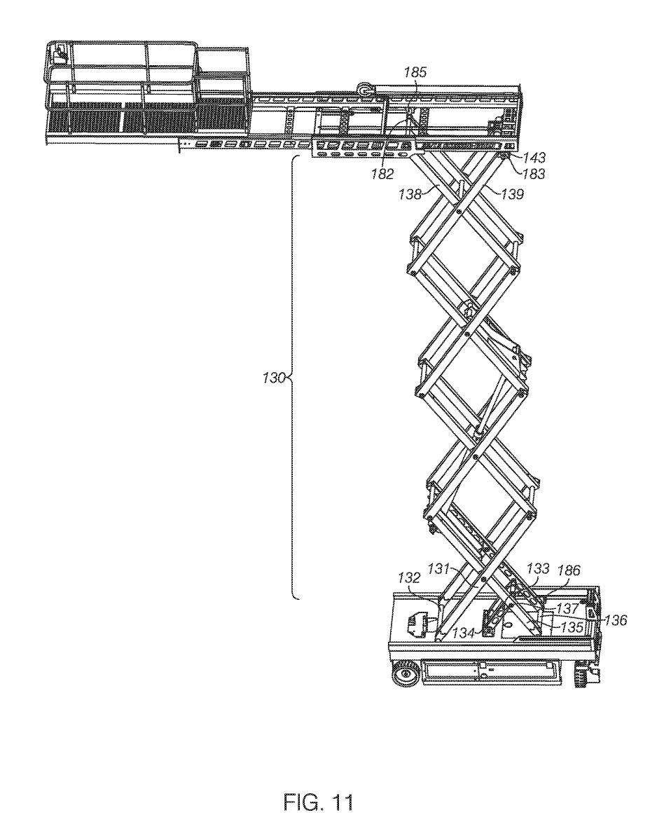

Referring now more specifically to scissor link assembly 130 as shown in FIG. 11; the scissor link assembly 130 includes a top front link 139 that is pivoted to the base-boom front bottom pin bracket 143 by pin 183, a top rear link 138 that is pivoted to a top sliding block 185 through a top pin 182. The sliding block 185 is fitted inside and can slide along the base bottom sliding channel 142 located at the bottom rear half of the base-boom 122. When scissor link assembly 130 folds and unfolds, since the top front link 139 is pivoted to the base-boom 122's front end by pin 183, so the top pin 182 of the top rear link 138 will slide along the base bottom sliding channel 142 on the base-boom 122 through sliding block 185.

Also as shown in FIG. 11, the scissor link assembly 130 includes a bottom rear link 131 with a bottom rear pin 132, a middle link 133 with a bottom middle pin 134 and top middle pin 137, and a bottom front link 135 with a bottom front pin 136. Bottom rear pin 132 and bottom front pin 136 fit inside can slide along the channel 143 (143 will be described late) on the chassis 140 through the bottom sliding block 186. The middle link 133's bottom end is pivoted to the chassis 140 by bottom middle pin 134 and the top end is pivoted to the bottom front link 135 by top middle pin 137. The center of rear bottom pin 132, the middle bottom pin 134 and the front bottom pin 136 are on the same horizontal surface and the middle link 133 is always parallel to bottom rear link 131 so when scissor links assembly 130 fold and unfold, the middle link 133 will swing around its bottom pivot link 134 and the rear bottom pin 132 and front bottom pin 136 will either move towards each other or apart from each other simultaneously and symmetrically with bottom middle pin 134 as the symmetric center. Thus the gravity center of the scissor links assembly 130 keeps unchanged and always stay at the center of the chassis 140.

In reference to the scissor links assembly 130, all scissor links pivot holes are preferably aligned horizontally except the top rear link 138 and top front link 139's top pivot pin 182 and 183 that connect the scissor links assembly 130 to the top base-boom 122. As shown in FIG. 10; the center of the top rear link pivot pin 182 is above that of the top front link pivot pin 183, causing the base-boom 122 not level, with its rear end tilted up by an angle α. As shown in FIG. 10, when the scissor links unfold and thus base boom 122 is raised up, the top sliding-block 185 and top rear pivot pin 182 will slide towards the front end of the base boom 122 and thus get closer to the top front pivot pin 183 which is pivoted at the pivot pin bracket 143 at the base-boom 122's front bottom. This movement will make the tilting angle α bigger so the further the unfold, the higher the rear end of the base boom 122 than its front end will be and thus the top boom 126 and middle boom 124 will all be tilted up on their rear end further. This angle α and thus the up tilt of the rear end of the base-boom 122 is used to partially offset the overall bending of the 3-section telescopic boom assembly 120 due to the gravity when fully extended and to keep the top-boom (the platform) 126 staying horizontal as much as possible.

Referring now to chassis 140 as shown in FIG. 12, the chassis in preferred embodiments has two front wheels 157 that have the driving motor to provide the ‘travel power’ and also two rear wheels 158. The two front wheels 157 may also steer and when they steer 90 degrees, they will be perpendicular to the rear wheels 158 and in this position when the two front wheels 157 travels, the whole chassis 140 will swing with one of the rear wheels 158 as the ‘swing center’. The chassis 140 has sliding-channels 153 on both sides at the top that allow the bottom sliding-blocks 186 of the scissor links 130 to fit in and slide. The chassis 140 has a middle-link-pivot-bracket 152 bolted at the middle of the top of the chassis 140. The middle link 133 is pivoted at the bottom to the middle-link-pivot-bracket 152 so the middle link 133 can swing around the middle-link-pivot-bracket 152 when scissor links assembly 130 folds or unfolds. At the same time, since the middle link 133 is pivoted to the bottom front link 135 at the top, this swing and linkage make bottom front link pin 136 and bottom rear link pin 132 slide along channel 153 toward or apart from each other simultaneously through bottom sliding block 186, thus the center of the scissor links 130 does not change and always stays at the center of middle-link-pivot-bracket 152 on chassis 140.

As shown in FIG. 12, the chassis 140 further comprises the counterweight 151 at its front end above and between the two fronts wheels 157 and the counterweight 157 provides the counterbalance when the 3-section telescopic booms 120 extend ‘to the backward’ on the top. It also provides increased traction force for the front wheels 157 when the front wheels drive to travel. The chassis also comprises drawlers 156 located on each side of the front half of the chassis 140 just next to the front wheels. These drawlers 156 hold the battery and hydraulic components inside and also act as the counterbalance when the 3-section telescopic boom assembly 120 extends to the backward on the top. Each drawler is locked by the latch on the top to the chassis 140 and may be opened to gain access to the components inside. The combination of the counterweight 151 and drawlers 156 makes the gravity center of the whole lift much close to the front end of chassis 140 and when the 3 section telescopic boom assembly 120 extends backward, the gravity center will shift to the middle area of the chassis. Two forklift holes 155 are located at the front end of chassis 140 allowing the whole lift can be picked up by forklift when the lift is in the stored position.

When the front wheels 157 turn left to the nearly 90 degree and travel, the chassis 140 will then swing around the rear wheel on the left rear side. The 3 section telescopic boom assembly 120 will also then swing together with the chassis 140. This swing allows the platform to cover more working area on the right when extended. When the front wheels 157 turn right to the nearly 90 degree and travel, the chassis may swing around the rear wheel on the right rear side. The 3 section telescopic boom 120 will then swing together with the chassis 140. This swing allows the platform to cover more working area on the left when extended.

The disclosure above encompasses multiple distinct inventions with independent utility. While each of these inventions has been disclosed in a particular form, the specific embodiments disclosed and illustrated above are not to be considered in a limiting sense as numerous variations are possible. The subject matter of the inventions includes all novel and non-obvious combinations and subcombinations of the various elements, features, functions and/or properties disclosed above and inherent to those skilled in the art pertaining to such inventions. Where the disclosure or subsequently filed claims recite “a” element, “a first” element, or any such equivalent term, the disclosure or claims should be understood to incorporate one or more such elements, neither requiring nor excluding two or more such elements.

Applicant(s) reserves the right to submit claims directed to combinations and subcombinations of the disclosed inventions that are believed to be novel and non-obvious. Inventions embodied in other combinations and subcombinations of features, functions, elements and/or properties may be claimed through amendment of those claims or presentation of new claims in the present application or in a related application. Such amended or new claims, whether they are directed to the same invention or a different invention and whether they are different, broader, narrower or equal in scope to the original claims, are to be considered within the subject matter of the inventions described herein.

1. A scissor-boom lift, comprises:
a telescopic boom assembly including;
a base-boom;
a middle-boom;
a top-boom; and
a power hoist
a scissor links assembly; and
a chassis;
wherein said scissor links assembly is coupled to said telescopic boom assembly at top and to the chassis at bottom;
wherein said telescopic boom assembly at top is arranged in telescopic series backwardly and horizontally comprising said base-boom, said middle-boom, and said top-boom powered by the power hoist to extend and alternately retract horizontally;
wherein said scissor links assembly in the middle is arranged with all links pivoted together parallelly and powered by a hydraulic cylinder to make simultaneous folding and alternately unfolding movement vertically; and
wherein said chassis has counterweights in between and on top of front wheels and the front wheels can steer 90 degrees to both right and left.

2. The scissor-boom lift of claim 1, wherein said telescopic boom assembly further comprises of:
a base-boom including;
a pivot pin bracket at the bottom front end;
a base-boom-top-channel on the left and right side of the top facing off each other;
a base-boom-bottom-channel on the left and right side of the bottom rear half facing off each other;
a control cable bracket at the top of front end;
a middle-boom extension pulley mounted at the middle of the bottom rear end;
a top-boom retraction pulley mounted at the left and right side of the bottom rear end;
a middle-boom including;
a middle-boom-channel on the left and right side of the top facing off each other;
a vertical extension cable pulley mounted at rear end and inside the left and right channel;
a retraction cable pulley mounted at the bottom front left and right side;
a control cable retractable drum mounted at the front end;
a top-boom including;
a working platform at the top;
a pivoted sliding block at the right and left side of the bottom next to the front end;
a horizontal extension cable pulley mounted at the right and left bottom next to the sliding block; and a control cable bracket mounted at the top front half;
a power hoist mounted at the bottom middle of the base-boom close to the front end;
a middle-boom extension cable, with one end wraps into the power hoist, the other end passes over the horizontal extension cable pulley mounted at the rear bottom of the base-boom and then is fixed to the middle-boom bottom front;
a middle-boom retraction cable, with one end wrapping into the power hoist, the other end being fixed to the middle-boom bottom front;
a top-boom simultaneous extension cable, with its middle section passing over the horizontal extension cable pulleys mounted at the front bottom of the top-boom and the two ends fixed to the base-boom front ends after going over the vertical cable extension pulleys mounted at the rear end of the middle-boom right and lift sliding channel and making 180 degree turn there; and
a top-boom simultaneous retraction cable, with its middle section passing over the top-boom retraction pulleys at the base-boom bottom rear end and the two ends fixed to the top-boom bottom front ends after going over the top-boom retraction pulleys mounted at the middle-boom bottom front and make 180 degree there.

3. The scissor-boom lift of claim 2, wherein;
said middle-boom nests into base-boom through their top left and top right channel accordingly, allowing the middle-boom to slide in and out from the rear end of base-boom;
said top-boom pivoted to sliding blocks on each side of its front end and said sliding blocks fit into the inside of the middle boom left and right channels, allowing the top-boom to slide in and out from the rear end of the middle-boom.

4. The scissor-boom lift of claim 2, wherein;
said middle-boom and said base-boom have open top and open rear end, the open tops on the said middle-boom and base-boom allow the said top-boom to slide in and fit into this open top space when fully retracted, the open rear end on the said middle-boom and base-boom allow the said top-boom to side in and out during the said telescopic boom assembly's extension and retractions.

5. The scissor-boom lift of claim 2,
wherein said middle-boom extension cable's one end is rewound to the power hoist right half drum from the top and alternately the bottom, the other end goes over a pulley located at the bottom rear end of the base-boom, making 180 degree turn and then is anchored to the said middle-boom bottom close to the front end;
wherein the said middle-boom retraction cable's one end is rewound to the power hoist left half drum from the bottom and alternately the top if the said middle-boom extension cable is rewound to the power hoist from the bottom, the other end is anchored to the said middle-boom bottom close to the front end; and
wherein the said middle-boom extension cable, the pulley located at the bottom rear end of base-boom, the middle-boom, the middle-boom retraction cable and the power hoist form a close loop and whenever power hoist rotate, one cable will be rewound in and the other will be rewound out.

6. The scissor-boom lift of claim 2, wherein said top-boom has the floor on the top surface and hand rails on the 4 sides, as well as the door on the front end, making it to become a working platform to allow the operator(s) to stand inside.

7. The scissor-boom lift of claim 6, wherein said top-boom floor are divided into 2 sections along the longitude direction of the scissor-boom lift, the front section only has the floor in the middle and is the walking in and walking out area allowing the operator to get in and get out of the working platform, the rear section has the full floor and is the working area where the operator(s) stands on during operation, the 2 areas are separated by a swing door.

8. The scissor-boom lift of claim 2, wherein said control cable bracket at the top front end of the base-boom, said control cable retractable drum at the top front end of the middle-boom and said control cable bracket at front end of the top-boom are aligned along the longitude direction of the scissor-boom lift, one end of the control cable is fixed to the control cable bracket on the base-boom, the other end is rewound to the left and alternately right half of the retractable drum from the top and alternately the bottom for several rounds, turned 180 degree and rewound to the right and alternately left if rewound in from the right half of the said control cable retractable drum and rewound out of the drum from the bottom and alternately top if rewound in from the bottom and then fixed to the control cable bracket on the top-boom, at any time, the control cable retractable drum will rewind the control cable by springs or motor inside the drum from both the top and bottom when top-boom retracts, and alternately release the control cable from both top and bottom when the top-boom extends.

9. The scissor-boom lift of claim 2, wherein said power hoist can be hydraulic or electric motor driven, the middle-boom extension and retraction cable, as well as the top-boom simultaneous extension and retraction cable, can be ropes and alternately chains and the cable pulleys can be sprockets.

10. The scissor-boom lift of claim 1, wherein the said scissor links assembly further comprises of:
a top front link, with pivot pin at the top to pivot to the base-boom bracket at the bottom front end of the base-boom;
a top rear link, with pivot pin at the top to pivot to the top sliding blocks that fits in and can slide along the left and right bottom channel of the base-boom;
a bottom front link, with pivot pin at the bottom to pivot into a bottom sliding block that fits in and can slide along the channel on top of the chassis;
a bottom rear link, with pivot pin at the bottom to pivot into a bottom sliding block that fits in and can slide along the channel on top of the chassis; and
a bottom middle link, parallel to either the bottom rear link or bottom front link and having pivot pin at the bottom to pivot to the bracket in the middle of the chassis and pivot pin at the top to pivot to either the bottom front link or bottom rear link.

11. The scissor-boom lift of claim 10,
wherein the center of the pivot pins of the said bottom front link, bottom rear link and middle link are on the same horizontal surface so scissor links will make symmetric and simultaneous movement during folding and unfolding, with pivot pin that pivots middle link to the chassis as the symmetric center;
wherein the pivot pin center at the top of the said top rear link is higher than the pivot pin center at the top of the said top front link in said scissor link assembly, causing the base-boom rear end and thus the telescopic boom assembly, higher than its front end in vertical direction.

12. The scissor-boom lift system scissor-boom lift of claim 1,
wherein the said scissor links is connected to the said telescopic boom assembly and the chassis in below combination;
wherein the said scissor links assembly is pivoted to the middle of the said chassis by the middle link bottom pin so during folding or unfolding, scissor links bottom front link and bottom rear link will slide simultaneously and symmetrically along the channel on the chassis either towards or apart from each other and the gravity center of the scissor links will not move and always align in the middle of the chassis; and
wherein the scissor links assembly is pivoted to the bottom front end of the base-boom, and thus the telescopic boom assembly, by the pivot pin at the top of the top front link so during folding and alternately unfolding, the pivot pin at the top of the top rear link will slide along the bottom channel of the base-boom on the rear half through the top sliding block so the telescopic boom assembly backend will extend out backwardly and its gravity center will move backward when scissor links assembly unfolds, when scissor links assembly folds, the telescopic boom assembly will retract from back to the front and its gravity center will move frontward when scissor links assembly folds.

13. The scissor-boom lift of claim 1, wherein said chassis further comprises of;
a sliding channels located on left and right side at the top of the said chassis
wherein
sliding blocks are fitted inside and are able to move along said sliding channels;
a middle-link-pivot-bracket fastened at the middle on the top of said chassis to hold the pivot pin that pivots the said middle link to chassis so that said middle link is able to swing around middle-link-pivot-bracket pivot pin center when said scissor links assembly is caused to fold and unfold;
a counterweight at the front end of the said chassis between and above the two front steering wheels;
a drawler on each side of the said chassis next to the front steering wheel and one side drawler hold battery or engines, the other side hold the hydraulic system and these drawlers also act as the counterbalance when the telescopic boom assembly extents out backwardly; and
two rear and two front wheels, with the front wheels have the driving motor and also can be steered at 90 degree angle to both left and right.

14. The scissor-boom lift of claim 13, wherein;
When the front wheels turn left to the nearly 90 degree and travel forward, the chassis will turn with rear left wheel as the turning center, the top-boom and thus the platform, if extended out, will swing in the opposite direction to the right to cover more working areas on the right; and
when the front wheels turn right to the nearly 90 degree and travel forward, the chassis will turn right with right wheel as the turning center, the top-boom and thus the platform, if extended out, will swing in the opposite direction to the left to cover more working areas on the left.

15. The scissor-boom lift of claim 1, further comprises a control box including;
a platform control selection button;
a travel control selection button;
a joystick;
a rock switch.

16. The scissor-boom lift of claim 15, wherein;
when the platform control selection button is pushed, joystick will control the scissor link assembly's folding and unfolding movement and rock switch will control the telescopic boom assembly's extension and retraction movement and alternately vice versa; and
when travel control selection button is pushed, joystick will control the chassis' forward and backward movement and rock switch will control the front wheels steering movement.
